(19) United States
(12) Patent Application Publication
(10) Pub. No.: US 2008/0014500 A1
(43) Pub. Date: Jan. 17, 2008

(54) BUTTON TYPE BATTERY

(75) Inventors: Won-Chull Han, Cheonan-city (KR); Takaki Morri, Cheonan-city (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/776,852

(22) Filed: Jul. 12, 2007

Related U.S. Application Data
(63) Continuation of application No. 10/653,468, filed on Sep. 3, 2003.

(30) Foreign Application Priority Data
Sep. 3, 2002 (KR) 2002-52915

(51) Int. Cl. H01M 2/02; H01M 4/66

(52) U.S. Cl. 429/178

(57) ABSTRACT

According to an aspect of the present invention, there is provided a button type battery including: a positive electrode active material pellet; a negative electrode active material pellet; a separator insulating the positive electrode material pellet and the negative electrode active material pellet from each other; a first collector body arranged to contact the positive active material pellet; a second collector body arranged to contact the negative active material pellet; a film exterior member enclosing the positive and negative electrode pellets, the separator, and the first and second collector bodies; a positive electrode lead connected to the first collector body contacting the positive electrode active material pellet and extending outside the film exterior member; and a negative electrode lead connected to the second collector body contacting the negative active material pellet and extending outside the film exterior member.

### CROSS-REFERENCE TO RELATED APPLICATIONS

This application is a continuation of U.S. patent application Ser. No. 10/653,468, filed Sep. 3, 2003, now pending, which claims the benefit of Korean Application No. 2002-52915, filed Sep. 3, 2002, in the Korean Intellectual Property Office, the disclosure of which is incorporated herein in it entirety by reference.

### BACKGROUND OF THE INVENTION

1. Field of the Invention

The present invention relates to a button type battery, and more particularly, to a button type battery made by forming an electrode active material into a pellet, depositing the same on a collector body, and covering the same with an aluminum pouch film.

2. Description of the Related Art

A typical button type battery having a very thin button-like shape is referred to as a coin type and is used for a variety of purposes. For example, the button type battery is widely used for electronic wrist watches. Also, the button type battery is used as a power source for devices displaying time and date in electronic apparatuses such as computers, cameras, or camcorders. Since the button type battery is provided separate from a main power, when the main power is cut off, the time display device continues to operate.

In a typical button type battery, an electrode active material pellet is accommodated in a case consisting of a cup and a can where the cup and the can have the function of a terminal with respect to an external circuit. Thus, to install a button type battery, a battery holder capable of accommodating a battery with a thin button shape is needed.

FIG. 1 is a sectional view illustrating a conventional button type battery. Referring to the drawing, in the typical button type battery, a positive active material pellet 2 fills the inside of a can 1 and a negative active pellet 4 fills the inside of a cup 3. The cup 3 is installed upside down, thus sealing an opening of the can 1. The positive active material pellet 2 and the negative active material pellet 4 are separated by a separator 5. Reference numeral 6 denotes a gasket.

The button type battery shown in FIG. 1 has the disadvantage that the battery quality is not stable. That is, although the electrode active material pellets need to closely contact the can 1 and the cup 3, a possibility exists that the electrode active materials do not uniformly adhere to an inner surface of the case when can 1 and cup 3 are joined by crimping. Accordingly, a space devoid of the pellets may be formed and performance of the battery deteriorates. Also, since the can 1 and the cup 3 work as terminals with respect to an external circuit, when the button type battery is accommodated, an additional suitable holder is needed.

### SUMMARY OF THE INVENTION

According to an aspect of the present invention, there is provided an improved button type battery.

According to an aspect of the present invention, there is provided a button type battery which is stable and reliable.

According to an aspect of the present invention, there is provided a button type battery which is made so that an electric connection terminal is conveniently handled.

According to an aspect of the present invention, there is provided a button type battery comprising: a positive electrode active material pellet; a negative electrode active material pellet; a separator insulating the positive electrode material pellet and the negative electrode active material pellet from each other; a first collector body arranged to contact the positive active material pellet; a second collector body arranged to contact the negative active material pellet; a film exterior member enclosing the positive and negative electrode pellets, the separator, and the first and second collector bodies; a positive electrode lead connected to the first collector body contacting the positive electrode active material pellet and extending outside the film exterior member; and a negative electrode lead connected to the second collector body contacting the negative active material pellet and extending outside the film exterior member.

According to an aspect of the present invention, the first collector body contacting the positive electrode active material pellet is made of aluminum or stainless steel and the second collector body contacting the negative electrode active material pellet is made of copper.

According to an aspect of the present invention, the positive electrode lead is made of aluminum or stainless steel and the negative electrode lead is made of nickel.

According to another characteristic of the present invention, the film exterior member is made of aluminum.

According to another aspect of the present invention, the film exterior member comprises a first film exterior member having a hollow cylindrical inner space and an open entrance at one end thereof and a second film exterior member having a flat shape corresponding to the open entrance of the first film exterior member.

According to another aspect of the present invention, the positive electrode lead and the negative electrode lead extend beyond the film exterior members.

According to another aspect of the present invention, the positive electrode active material pellet and the negative electrode active material pellet are formed by press processing each of the active materials in a mold.

According to another aspect of the present invention, the positive and negative electrode active material pellets have a disk shape.

To achieve the above and/or other aspects of the present invention, there is provided a button type battery comprising: positive electrode plate including a first mesh collector body and a positive active material pressed against the first mesh collector body; a negative electrode plate including a second mesh collector body and a negative active material pressed against the second mesh collector body; a separator insulating the negative electrode plate and the positive electrode plate from each other; a film exterior member enclosing the positive electrode plate, the negative electrode plate, and the separator; a positive electrode lead connected to the first mesh collector body of the positive electrode plate and extending outside the film exterior member; and a negative electrode lead connected to the second collector body of the negative electrode plate and extending outside the film exterior member.

According to an aspect of the present invention, the first mesh collector body against which the positive electrode active material is pressed is made of aluminum or stainless steel and the second mesh collector body against which the negative active material is pressed is made of copper.

According to an aspect of the present invention, the positive active material of the positive electrode plate, the first mesh collector body to which the positive electrode lead is connected, the negative active material of the negative electrode plate, the second mesh collector body to which the negative electrode is connected, and the separator are press processed in a mold to have a cylindrical shape.

According to an aspect of the invention, there is provided a button type battery comprising: a positive active material pellet and a negative active material pellet, each formed by press-processing; a separator insulating the positive active material pellet and the negative active material pellet; a film exterior member enclosing the positive active material pellet, the negative active material pellet, and the separator; and a positive lead and a negative lead connected to the positive active material pellet and the negative active material pellet, respectively, and extending outside the film exterior member.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a sectional view illustrating a conventional button type battery;

FIG. 2 is a sectional view illustrating a button type battery according to a first aspect of the present invention;

FIG. 3 is an exploded perspective view illustrating the structure of part of the battery shown in FIG. 2;

FIG. 4 is a perspective view illustrating the button type battery shown in FIG. 2; and

FIG. 5 is an exploded perspective view illustrating a button type battery according to another aspect of the present invention.

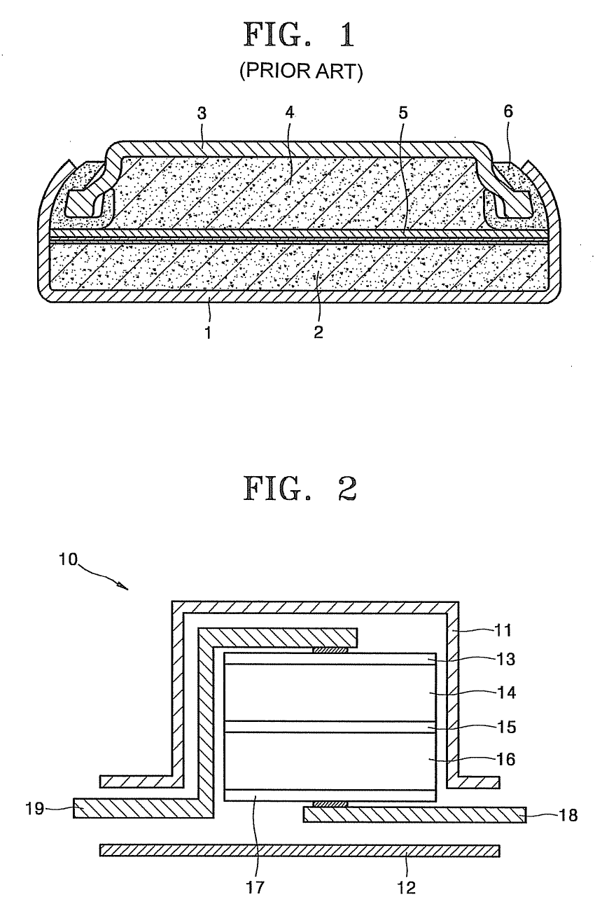

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Referring to FIGS. 2, 3, and 4, a button type battery according to an aspect of the present invention may include a positive electrode plate made of a positive active material pellet 14 arranged on a first collector body 13 with a shape of a flat disk, a negative electrode plate made of a negative active material pellet 16 arranged on a second collector body 17 with a shape of a flat disk, a separator 15 arranged between the positive electrode plate and the negative electrode plate, and first and second film exterior members 11 and 12 enclosing the positive electrode plate, the negative electrode plate, and the separator 15. A positive electrode lead 19 is connected to the first collector body 13 of the positive electrode plate and drawn outside between the first and second film exterior members 11 and 12. A negative electrode lead 18 is connected to the second collector body 17 of the negative electrode plate and drawn outside between the first and second film exterior members 11 and 12.

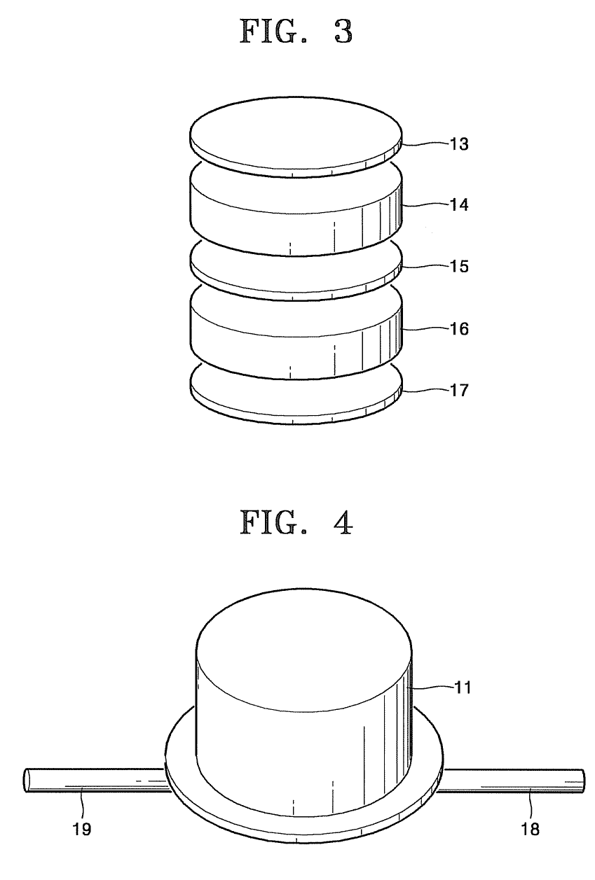

The first collector body 13 of the positive electrode plate is preferably made of aluminum or stainless steel. The first collector body 13, which has the shape of a very thin flat plate as shown in FIG. 3, may also have the shape of a mesh or web or any other shape. The first collector body 13 shown in FIGS. 2 through 4 is made of a thin flat plate. The second collector body 17 of the negative electrode plate may be made of copper and may have a shape of a very thin flat plate or a mesh or web or any other shape.

The positive active material pellet 14 and the negative active material pellet 16 are made by processing positive and negative active materials to have a predetermined thickness and shape by a press process. In the button type battery, the pellets 14 and 16 may have a thin disk shape. Any material typically used for a button type battery can be employed as the active material. To improve processing of the active material to a pellet having a predetermined shape, a conductive agent and a binder may be added. Also, the separator can be manufactured of a material typically used in a battery.

The positive electrode lead 19 is spot-welded to the first collector body 13 of the positive electrode plate while the negative electrode lead 18 is spot-welded to the second collector body 17 of the negative electrode plate. The positive electrode lead 19 extends along the side of the positive and negative active material pellets 14 and 16 so as to be drawn outside through a lower surface of the button type battery. The positive electrode lead 19 is insulated so as not to contact the negative active material pellet 16 or the second collector body 17 of the negative electrode plate. The negative active material pellet 16 or the second collector body 17 of the negative electrode plate can also be insulated. The insulation process can be made by a variety of methods, for example, by using an insulation tape or performing insulation coating.

FIG. 4 is a perspective view illustrating the button type battery shown in FIG. 2.

The first and second film exterior members 11 and 12 can be made of an aluminum pouch material. The first film exterior member 11 arranged in the upper portion of the button type battery, may be cylindrical and have an inner hollow cylindrical space. One end portion of the first film exterior member 11 forms an open entrance so that the collector bodies and the active material pellets are accommodated therein. In contrast, the second film exterior member 12 arranged in the lower portion of the button type battery has a flat shape corresponding to the open entrance of the first film exterior member 11.

The positive electrode lead 19 and the negative electrode lead 18 may extend beyond the first and second film exterior members 11 and 12. Thus, as shown in FIG. 4, the respective leads 18 and 19 can extend beyond the bottom surface of the button type battery.

The button type battery described in FIGS. 2 through 4 can be manufactured by the following method.

To manufacture the negative active material pellet 16, a stainless steel mold (not shown) having a diameter of 16-20 mm and a depth of 1 mm may be used. A mixture of graphite and a binder (PVdF) in the ratio of 90:10 is introduced in the mold and pressed at a pressure of approximately 300 Kg/cm². As a result of the press processing, the mixture of graphite and binder has the shape of the negative active material pellet 16 shown in FIG. 3.

To manufacture the positive active material pellet 14, a stainless steel mold (not shown) having a diameter of 16-20 mm and a depth of 1 mm may be used. A mixture of LiCoO₂, a binder (PVdF), and a conductive agent (acetylene black) in the ratio of 92:5:3 is inserted in the mold and pressed at a pressure of approximately 300 Kg/cm². As a result of the press processing, the mixture has a shape of the positive active material pellet 14 shown in FIG. 3.

Then, the first film exterior member 11 having an inner hollow space with dimensions such as a 16-20 mm diameter and a 2 mm depth is formed using an aluminum material having a thickness of approximately 30 μm. The inner hollow space of the first film exterior member 11 can accommodate the collector bodies 13 and 17, the separator 15, and the negative and positive electrode leads 18 and 19, respectively, together with the negative active material pellet 16 and the positive active material pellet 14.

The dimensions referred to concerning the first film exterior member 11 are not limited thereto and other dimensions can be adopted according to design. When the above dimensions are adopted, due to ductility of the aluminum material itself, the above elements can be sufficiently accommodated in the inner hollow space.

The second collector body 17 accommodated in the first film exterior member 11 may be made of copper having a thickness of approximately 50 μm. Also, the first collector body 13 may be made of aluminum or stainless steel having a thickness of approximately 50 μm.

After sequentially stacking the second collector body 17, the negative active material pellet 16, the separator 15, the positive active material pellet 14, and the first collector body 13, the negative electrode lead 18 and the positive electrode lead 19 are spot welded to the collector bodies 17 and 13 of the negative electrode plate and the positive electrode plate, respectively. The negative electrode lead 18 spot-welded to the second collector body 17 may be made of nickel. The positive electrode lead 19 spot-welded to the first collector body 13 may be made of stainless steel or aluminum or any other material.

After the collector body, the separator, and the active material pellet are stacked and spot-welding is performed, they are inserted in the inner hollow space of the first film exterior member 11 and an electrolyte is injected. The electrolyte may be in a liquid state or gel state. The electrolyte in a liquid state can be manufactured by dissolving any of electrolyte salts consisting of LiPF₆, LiBF₄, and LiClO₄ in any of solvents consisting of carbonate, esters, sulfolane, and nitrile compound. Also, a gel electrolyte can be prepared by filling an electrolyte material in polymer matrix including polymerization resultants of acrylate, urethane compound, and a polyether compound.

The second film exterior member 12 is separately manufactured from or integrally with the first film exterior member 11 having a hollow cylindrical space and used to close the open entrance of the first film exterior member 11. That is, the second film exterior member 12 is made of aluminum having a shape corresponding to the open entrance of the first film exterior member 11 where the second film exterior material is heated and pressed for two minutes at a pressure of approximately 50 Kg/cm² to be welded to the first film exterior member 11 after the electrolyte material is filled in the hollow space of the first film exterior member 11. Alternatively, the first and second film exterior members 11 and 12 can be combined in an ultrasonic wave welding method.

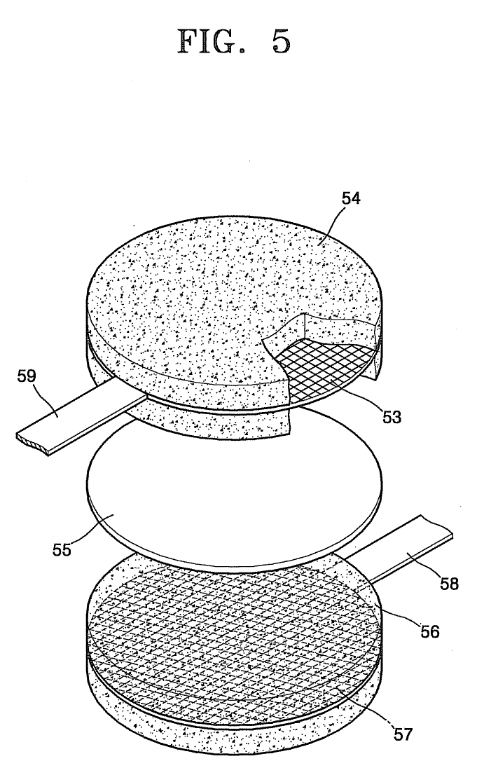

FIG. 5 is an exploded perspective view illustrating a button type battery according to another aspect of the present invention.

FIG. 5 shows the collector body in a mesh form.

A first collector body 53 is formed on a mesh having a diameter of approximately 20 mm. The first collector body 53 may be formed of aluminum. A positive electrode lead 59 may be spot-welded to the first collector body 53 in the mesh form. The positive electrode lead may be formed of aluminum. Also, a second collector body 57 is formed on a mesh having a diameter of approximately 20 mm. A negative electrode lead 58 may be spot-welded to the second collector body 57 in the mesh form. The negative electrode lead 58 may be formed of copper. The negative active material 56 is manufactured from a mixture in which graphite and a binder (PVdF) are mixed in a ratio of 90:10. Also, the positive active material is manufactured from a mixture in which LiCoO₂, a binder (PVdF), and a conductive agent (acetylene black) have a ratio of 92:5:3.

The collector bodies 53 and 57 in the mesh form, the negative active material, and the positive active material 54 are pressed in a mold made of stainless steel, together with the separator 55. As a result of the press processing, the negative active material 56 forms a mass by being pressed with respect to the second collector body 57 in the mesh form, as indicated by reference numeral 56 in FIG. 5. The positive active material forms a mass by being pressed with respect to the first collector body 53 in the mesh form, as indicated by reference numeral 54 in FIG. 5. The pressed active material masses are illustrated separately by separator 55, in FIG. 5.

The mold used in the press processing may have a cylindrical inner space with dimensions such as a 20 mm diameter and a 2 mm depth. During the press processing, the mold in which the collector bodies 53 and 57, the active materials, and the separator are sequentially stacked is pressed at a pressure of about 200 kg/cm² to form a cylindrical shape corresponding to the inner space of the mold.

Next, the collector bodies 53 and 57 and the active material masses 54 and 56, and the electrolyte material, are inserted in the inner space of the filing exterior member (that is the same as the first film exterior member 11 of FIG. 2) manufactured of aluminum. The additionally manufactured flat plate type aluminum film exterior member (that is the same as the second film exterior member 12 of FIG. 2) is combined to the film exterior member.

In the embodiments shown in FIGS. 2 through 5, the positive active material pellet and the negative active material pellet are configured on the disk shaped collector body or the disk shaped mesh collector body. However, in another aspect of the invention not shown, a button type battery can be configured without the collector body. In that case, the positive electrode lead 19 is directly bonded to the positive active material pellet 14 while the negative electrode lead 18 is directly bonded to the negative active material pellet 16.

As described above, in the button type and coin type battery according to the present invention, since the positive active material pellet, the negative active material pellet, and the separator are enclosed using the aluminum pouch film exterior member, a uniform combination is possible without an empty space in the electrode active materials thereby improving battery performance. Also, since the respective leads are directly bonded to the active material pellets or welded thereto via the disk shaped collector body, the possibility of short-cut is reduced. Furthermore, since the respective leads are extended beyond the lower surface of the button type battery, a holder to maintain the button type battery is easily configured.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A button type battery comprising:
positive and negative active material pellets;
a separator insulating the positive and negative active material pellets from one another;
first and second collector bodies respectively arranged to contact the positive and negative active material pellets;
a two part film exterior member, including a relatively flat first part and a second part having relatively flat sections and a bulge, the bulge and a first portion of the first part encasing the positive and negative active material pellets, the separator, and the first and second collector bodies; and
positive and negative leads, respectively connected to the first and second collector bodies, extending outside the film exterior member via spaces defined between second portions of the first part and the relatively flat sections of the second part.

2. The button type battery as claimed in claim 1, wherein the first collector body comprises aluminum or stainless steel and the second collector body comprises copper.

3. The button type battery as claimed in claim 1, wherein the positive lead comprises aluminum or stainless steel and the negative lead comprises nickel.

4. The button type battery as claimed in claim 1, wherein the two part film exterior member comprises aluminum.

5. The button type battery as claimed in claim 1, wherein the bulge has a hollow cylindrical inner space and an open entrance at one end thereof.

6. The button type battery as claimed in claim 1, wherein the positive and negative active material pellets are formed by a press processing of each of the active materials in a mold.

7. The button type battery as claimed in claim 1, wherein the positive and negative active material pellets each have a disk shape.
